(19) United States
(12) Patent Application Publication
(10) Pub. No.: US 2013/0191019 A1
(43) Pub. Date: Jul. 25, 2013

(54) METHODS AND APPARATUSES FOR USE IN MOBILE DEVICE STATE/TRAJECTORY ESTIMATION WITHIN AN INDOOR ENVIRONMENT

(71) Applicant: Payam Pakzad, Mountain View, CA (US)

(72) Inventor: Payam Pakzad, Mountain View, CA (US)

(73) Assignee: QUALCOMM Incorporated, San Diego, CA (US)

(21) Appl. No.: 13/356,140

(22) Filed: Jan. 23, 2012

(51) Int. Cl. G01C 21/00

(52) U.S. Cl. 701/454

(57) ABSTRACT

Various techniques are provided which may be implemented in one or more methods, apparatuses, and/or articles of manufacture for use with and/or in a mobile device to obtain this date/trajectory estimation us within an indoor environment. In an example, a mobile device may apply a motion model to propagate an estimated state of the mobile device from a first state corresponding to a first location of an electronic map representing an indoor environment to a second state corresponding to a second location of the electronic map, based, at least in part, on one or more sensed parameters. The mobile device may further validate the estimated state as propagated in response to a determination that a trajectory from the first location to the second location crosses a transition feature of a barrier presented by at least one obstacle identified in the electronic map.

### BACKGROUND

1. Field

The subject matter disclosed herein relates to electronic devices, and more particularly to methods, apparatuses and articles of manufacture for use in a mobile device to determine an estimated state/trajectory within an indoor environment.

2. Information

The Global Positioning System (GPS) represents one type of Global Navigation Satellite System (GNSS), which along with other types of satellite positioning systems (SPS) provide or otherwise support signal-based position location capabilities (e.g., navigation functions) in mobile devices, and particularly in outdoor environments. However, since some satellite signals may not be reliably received and/or acquired by a mobile device within an indoor environment or other like mixed indoor/outdoor environments, different techniques may be employed to enable position location services.

Mobile devices may obtain a position fix by measuring ranges to three or more terrestrial transmitters (e.g., wireless access points) which are positioned at known locations. Such ranges may be measured, for example, by obtaining a MAC ID address from signals received from such access points and measuring one or more characteristics of signals received from such access points such as, for example, signal strength, round trip delay, just to name a few examples. Such measurements may be viewed as “direct measurements” in that they give information regarding a current position (such as a range to a transmitter fixed at a known location) when obtained.

Measurements of ranges to one or more transmitters may be utilized for obtaining an estimate of a location of the mobile device. In a particular example where measurements of ranges to more than three transmitters is available, the accuracy of such an estimate may vary considerably based upon which particular measurements to which particular transmitters are selected for obtaining such an estimate of a location of a mobile device. For example, an inaccuracy in a measurement of a range to at least one transmitter can significantly degrade the accuracy of a resulting estimate a location of a mobile device.

In addition to the use of direct measurements, a mobile device may incorporate “indirect measurements” indicative of relative motion to assist in obtaining an estimate of a current position estimate. Such indirect measurements may include, for example, measurements obtained from signals generated by sensors such as, for example, accelerometers, pedometers, compasses or gyroscopes. Also, in certain environments and applications, movement of a mobile device may be constrained by physical obstructions to predetermined areas or paths. In an indoor environment, for example, movement of a mobile device may be constrained to predetermined paths or routes defined according to walls, doorways, entrances, stairways, etc. As such, a current location of a mobile device may be presumed to be constrained by such predetermined areas or paths.

With regard to an indoor environment, a routability graph defining feasible paths may be considered in estimating a trajectory and/or otherwise determining a position location of a user of a mobile device within an indoor environment. Unfortunately, certain indoor environments may require routability graphs that may, at times, be prohibitively large in size to provide adequate resolution to determine a likely trajectory that a user of a mobile device may take.

### SUMMARY

In accordance with certain aspects, an example method of estimating a state of a mobile device is provided. The example method comprises, with the mobile device: applying a motion model to propagate an estimated state of the mobile device from a first state corresponding to a first location of an electronic map representing an indoor environment to a second state corresponding to a second location of the electronic map, based, at least in part, on one or more sensed parameters; and validating the estimated state as propagated in response to a determination that a trajectory from the first location to the second location crosses a transition feature of a barrier presented by at least one obstacle identified in the electronic map.

In accordance with other certain aspects, an example apparatus is provided for use in a mobile device. The example apparatus comprises: means for propagating an estimated state of the mobile device from a first state corresponding to a first location of an electronic map representing an indoor environment to a second state corresponding to a second location of the electronic map, based, at least in part, on one or more sensed parameters; and means for validating the estimated state as propagated in response to a determination that a trajectory from the first location to the second location crosses a transition feature of a barrier presented by at least one obstacle identified in the electronic map.

In accordance with still other certain aspects, a mobile device may be provided which comprises: memory, and one or more processing units configured to: use a motion model to propagate an estimated state of the mobile device from a first state corresponding to a first location of an electronic map representing an indoor environment to a second state corresponding to a second location of the electronic map, based, at least in part, on one or more sensed parameters; and validate the estimated state as propagated in response to a determination that a trajectory from the first location to the second location crosses a transition feature of a barrier presented by at least one obstacle identified in the electronic map.

In accordance with yet other certain aspects, an article of manufacture may be provided which comprises a non-transitory computer readable medium having computer implementable instructions stored therein that are executable by at least one processing unit of a mobile device to: apply a motion model to propagate an estimated state of the mobile device from a first state corresponding to a first location of an electronic map representing an indoor environment to a second state corresponding to a second location of the electronic map, based, at least in part, on one or more sensed parameters; and validate the estimated state as propagated in response to a determination that a trajectory from the first location to the second location crosses a transition feature of a barrier presented by at least one obstacle identified in the electronic map.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a schematic block diagram illustrating an example environment comprising a mobile device to determine its estimated state/trajectory within an indoor environment of a structure based, at least in part, on a routability graph, in accordance with an implementation.

FIG. 2 is a schematic block diagram illustrating certain features of an example computing platform in the form of a mobile device to determine its estimated state/trajectory within an indoor environment of a structure based, at least in part, on a routability graph, in accordance with an implementation.

FIG. 3 is an example floor plan diagram which may be encoded via an electronic map or other like diagram and which may identify certain obstacles within an indoor environment of the structure that may present barriers to a user of a mobile device, in accordance with an implementation.

FIG. 4 is an example grid of points having interconnected edges there between that may represent feasible paths to a user of a mobile device, in accordance with an implementation.

FIG. 5 is a projection of an example grid of points, e.g., as in FIG. 4, overlaid on an example floor plan diagram, e.g., as in FIG. 3, in accordance with an implementation.

FIG. 6 is an illustration of an example routability graph derived from FIG. 5, in accordance with an implementation.

FIG. 7 is an example illustration of a routability graph as in FIG. 6 further illustrating several example transition features for which an estimated state/trajectory of a mobile device from a first point to a second point may be selectively validated even though the points may not be directly connected by an edge representing a feasible path for a user of the mobile device, in accordance with an implementation.

FIG. 8 is a flow diagram illustrating certain features of an example process or method for use in a mobile device to determine its estimated state/trajectory within an indoor environment of a structure based, at least in part, on a routability graph, in accordance with an implementation.

### DETAILED DESCRIPTION

Data processing techniques are provided herein which may be implemented as various methods, apparatuses, or otherwise provided in articles of manufacture for use with a mobile device that may comprise or take the form of a special purpose computing platform.

In accordance with certain example implementations, a mobile device may apply or otherwise use a motion model to propagate its estimated state from a first state corresponding to a first location of an electronic map representing an indoor environment to a second state corresponding to a second location of the electronic map. Such propagation may, for example, be based, at least in part, on one or more sensed parameters, e.g. obtained from one or more sensors on board the mobile device. For example, one or more sensed parameters may be based, at least in part, on one or more inertial sensor measurements, one or more environmental sensor measurements, one or more wireless signal measurements obtained using one or more receivers, and/or the like or some combination thereof. A mobile device may, for example, validate an estimated state as propagated in response to a determination that a trajectory from the first location to the second location crosses a transition feature of a barrier presented by at least one obstacle identified in the electronic map.

In accordance with certain example implementations, a mobile device may determine whether a trajectory from a first location to a second location crosses a transition feature of a barrier based, at least in part, on a routability graph corresponding to an electronic map of an indoor environment. In certain instances, a routability graph may represent a discrete quantization of a plane overlaying such an electronic map, and may comprise a plurality of discrete points wherein adjacent points are connected by an edge if there are no intervening obstacles identified in the electronic map between the adjacent points. Thus, an edge may represent a feasible path for a user of a mobile device when navigating within an indoor environment associated with such an electronic map. In certain example implementations, a mobile device may identify at least one of the plurality of discrete points with at least one of a first location or a second location associated with the propagation provided by the motion model. A mobile device may then, for example, determine whether a trajectory from the first location to the second location crosses a transition feature of a barrier based, at least in part, on a determination that the identified discrete point(s) is proximate to a transition feature of a barrier. Accordingly, under certain conditions, an estimated state as propagated may cross over a barrier associated with one or more obstacles within the indoor environment and which might normally not be considered a feasible path in a routability graph and may nonetheless be validated.

In certain example implementations at least one barrier may be identified based, at least in part, on one or more obstacles within an electronic map for at least a portion of an indoor environment. In certain instances a “transition feature” of a barrier may, for example, comprise a terminus portion of one or more obstacles (e.g., an end of a wall, end of the desk, etc.), a corner portion of one or more obstacles (e.g., a corner of a wall, a corner of the closet, etc.), a faceted portion of one or more obstacles (e.g., an angled section of a wall that is greater or less than 90 degrees, etc.), a curved or non-planar portion of one or more obstacles (e.g., a curving wall, a rounded or faceted corner of a wall or desk, etc.), a distal portion of one or more obstacles (e.g., one or more features extending outwardly, a windowed or other like feature framing part of an entryway or doorway, a hand-rail, a line-queuing or other like pedestrian traffic-directing barrier, etc.), a portion of said one or more obstacles forming part of an entryway, or a portion of said one or more obstacles forming part of a doorway, and/or the like or some combination thereof. In other words, in certain instances, a transition feature may comprise a portion of an obstacle that a user of a mobile device may pass by when entering or exiting a room or a space, or when altering their course while navigating within an indoor environment.

In certain example implementations, a “transition feature” of at least one barrier may comprise a portion of one or more obstacles having a cross-sectional area measurement that is less than a cross-sectional area threshold value. For example, one or more obstacles forming a vertical support member of a structure, a utility service riser within a structure, a design element within the structure, and/or the like or some combination thereof may present a cross-sectional area measurement (e.g., identifiable using an electronic map) that may be less than a cross-sectional area threshold value. For example, if a cross-sectional area threshold value is set at one square meter, then a barrier presented by a support member of a structure having a cross-sectional area measurement that is less than one square meter may be considered a “transition feature”.

As illustrated by way of further example, a routability graph may be represented as a plurality of discrete points (e.g., grid points, etc.) having edges that represent feasible paths for a user of a mobile device from a location within the structure corresponding to one point on the grid to another location within the structure corresponding to another point on the grid. In certain example implementations, all or part of a routability graph may comprise grid points that may be distributed in a uniform manner. In other example implementations grid points may be distributed in a non-uniform manner. Additionally, while certain examples illustrated herein depict a uniformly distributed square pattern of grid of points with each interior grid point having eight edges extending therefrom, in certain other implementations grid points may be distributed one or more different patterns, and/or may have a potential for fewer than eight edges or greater than eight edges extending therefrom.

In certain example implementations, a mobile device may determine its estimated state/trajectory by applying a motion model that may attempt to propagate an estimated state of the mobile device from a first state corresponding to the first point to a second state corresponding to the second point based, at least in part, on one or more sensed parameters. For example, in certain instances a motion model may comprise a particle filter and/or the like. In certain example instances, one or more sensed parameters may be based, at least in part, on one or more inertial sensor measurements, one or more environmental sensor measurements, one or more received wireless signal measurements, and/or the like or some combination thereof.

In certain example implementations, a mobile device may determine whether a first point and/or a second point are proximate to a transition feature of at least one barrier based, at least in part, on whether such point(s) are within a threshold distance of a transition feature. For example, in certain instances a threshold distance may be determined based, at least in part, on at least one distance between adjacent grid points represented in the routability graph. For example, in certain instances a threshold distance may be determined which is less than or equal to a distance between two adjacent grid points represented in a routability graph. In certain example instances, a threshold distance may be determined based, at least in part, on a type of obstacle associated with a particular barrier. For example, a threshold distance for a structural support beam may be different than a threshold distance for an entryway or doorway. In still other example instances, a threshold distance may be determined based, at least in part, on a motion state associated with the mobile device. For example, a threshold distance may be different for a user having a motion state indicative of a leisurely pace down for a motion state indicative of a running or quickened pace of a user. It should be kept in mind that an actual trajectory and/or an estimated trajectory need not necessarily adhere to the edges represented in a routability graph.

In certain example implementations, a mobile device may further determine its estimated position location within an indoor environment based, at least in part, on a selectively validated estimated state/trajectory. For example, a selectively validated state/trajectory may correspond to a particular position location of an indoor environment in an electronic map.

As used herein the term “structure” may, for example, apply to (all or part of) one or more natural and/or man-made physical arrangements of object(s), the knowledge of which may be of use to a user of mobile device. For example, a structure may comprise all or part of a building that a user of a mobile device may enter into, exit from, and/or otherwise move about within. Some example structures may comprise a mixture of indoor and outdoor spaces.

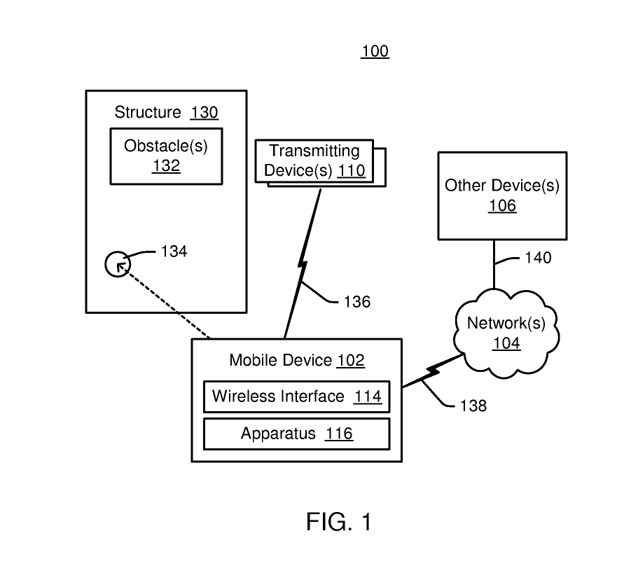

FIG. 1 is a schematic block diagram illustrating an example environment 100 comprising a mobile device 102 having an apparatus 116 to determine an estimated state/trajectory of mobile device 102 within an indoor environment based, at least in part, on a routability graph associated with an electronic map of an indoor environment within a structure 130 having one or more obstacles 132. As illustrated, mobile device 102 may be located at position 134 within a structure 130, at a particular time. A mobile device 102 may, for example, comprise a computing platform that may be operated to determine at least its estimated state/trajectory, in accordance with an implementation.

As shown environment 100 may further comprise one or more other devices 106 that may be operatively coupled to mobile device 102 via one or more network(s) 104. For example, mobile device 102 may communicate using a wireless interface 114 over a wireless communication link 138, network(s) 104, and one or more wired or wireless communication links 140 to one or more other devices 106. By way of example, in certain instances mobile device 102 may obtain all or part of one or more electronic maps, one or more routability graphs, and/or other like information or some combination thereof encoded in one or more data files and/or one or more instruction files from one or more other devices 106. By way of example, in certain instances mobile device 102 may transmit/receive one or more messages, one or more electronic files, etc., via wireless interface 114 to/from one or more other devices 106 directly, and/or indirectly via network(s) 104. For example, in certain instances mobile device 102 may transmit information to one or more other devices 106 identifying an estimated position location and/or other like information relating to mobile device 102 as may be encoded in one or more electrical signals.

Apparatus 116 may, for example, comprise a positioning function that may be provided, in whole or part, in mobile device 102. Apparatus 116 may, for example, use one or more wireless signal receivers within wireless interface 114 and/or a location receiver (not shown) to acquire one or more wireless signals 136 transmitted from one or more transmitting devices 110, and which may be used by device 102 to estimate its position location relative to one or more transmitting devices 110, an electronic map associated with structure 130, etc. Transmitting devices 110 may, for example, represent one or more dedicated transmitting devices associated with one or more satellite-based and/or terrestrial-based location services. In certain example instances, transmitting devices 110 may comprise one or more transmitting devices (e.g., one or more access points of a wireless network, one or more base stations of a cellular network, etc.) arranged within or about structure 130.

By way of example, mobile device 102 may comprise any electronic device that may be moved about by a user within structure 130. Thus, by way of some examples, mobile device 102 may comprise a cell phone, a smart phone, a computer (e.g., a personal computer such as a laptop computer, a tablet computer, a wearable computer, etc.), a navigation aid, a digital book reader, a gaming device, a music and/or video player device, a camera, etc., just to name a few.

Apparatus 116 is representative of circuitry, such as, e.g., hardware, firmware, a combination of hardware and software, and/or a combination of firmware and software or other like logic that may be provided in mobile device 102.

In certain example implementations, mobile device 102 may function exclusively or selectively as a stand-alone device, and may provide a one or more capabilities/services of interest/use to a user. In certain example implementations, mobile device 102 may communicate in some manner with one or more other devices, for example, as illustrated by the wireless communication link to the cloud labeled network(s) 104. Network(s) 104 may be representative of one or more communication and/or computing resources (e.g., devices and/or services) which mobile device 102 may communicate with or through, e.g., via wireless interface 114 using one or more wired or wireless communication links. Thus, as mentioned in certain instances mobile device 102 may receive (or send) data and/or instructions via network(s) 104. In certain instances, mobile device 102 may, for example, not only receive a signal from a transmitting device 110, but may also transmit a signal to such a transmitting device (e.g., having a receiver).

In certain example implementations, mobile device 102 may be enabled to receive signals associated with one or more wireless communication networks, location services, and/or the like or any combination thereof which may be associated with one or more transmitting devices 110 and/or network(s) 104.

Mobile device 102 may, for example, be enabled (e.g., via wireless interface 114) for use with various wireless communication networks such as a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), Time Division Synchronous Code Division Multiple Access (TD-SCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, for example. Wireless communication networks may include so-called next generation technologies (e.g., “4G”), such as, for example, Long Term Evolution (LTE), Advanced LTE, WiMAX, Ultra Mobile Broadband (UMB), and/or the like.

In certain example implementations, mobile device 102 may be enabled (e.g., via wireless interface 114 or other location receiver) for use with various location service(s), such as, a Global Navigation Satellite System (GNSS), or other like satellite and/or terrestrial locating service, a location based service (e.g., via a cellular network, a WiFi network, etc.).

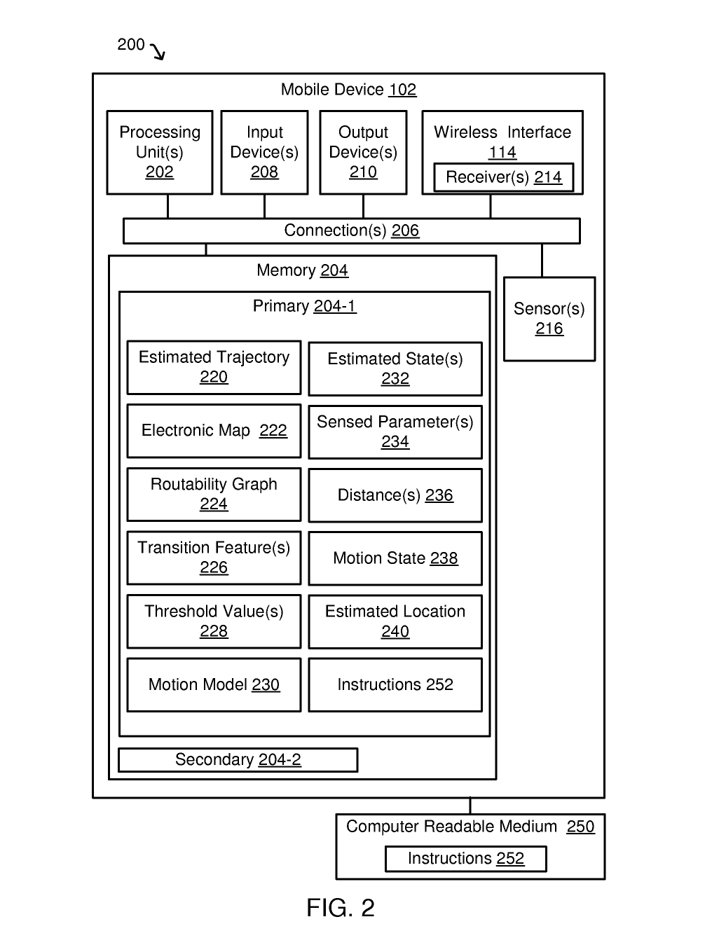

FIG. 2 is a schematic block diagram illustrating certain features of an example computing platform 200 shown in the form of mobile device 102 to determine its estimated state/trajectory within an indoor environment of a structure based, at least in part, on a routability graph, in accordance with an implementation.

As illustrated mobile device 102 may comprise one or more processing units 202 to perform data processing (e.g., in accordance with the techniques provided herein) coupled to memory 204 via one or more connections 206. Processing unit(s) 202 may, for example, be implemented in hardware or a combination of hardware and software. Processing unit(s) 202 may be representative of one or more circuits configurable to perform at least a portion of a data computing procedure or process. By way of example but not limitation, a processing unit may include one or more processors, controllers, microprocessors, microcontrollers, application specific integrated circuits, digital signal processors, programmable logic devices, field programmable gate arrays, or the like, or any combination thereof.

Memory 204 may be representative of any data storage mechanism. Memory 204 may include, for example, a primary memory 204-1 and/or a secondary memory 204-2. Primary memory 204-1 may comprise, for example, a random access memory, read only memory, etc. While illustrated in this example as being separate from the processing units, it should be understood that all or part of a primary memory may be provided within or otherwise co-located/coupled with processing unit(s) 202, or other like circuitry within mobile device 102. Secondary memory 204-2 may comprise, for example, the same or similar type of memory as primary memory and/or one or more data storage devices or systems, such as, for example, a disk drive, an optical disc drive, a tape drive, a solid state memory drive, etc. In certain implementations, secondary memory may be operatively receptive of, or otherwise configurable to couple to, computer readable medium 250. Memory 204 and/or computer readable medium 250 may comprise instructions 252 associated with data processing, e.g., in accordance with the techniques and/or apparatus 116 (FIG. 1), as provided herein.

Mobile device 102 may, for example, further comprise one or more user input devices 208, one or more output devices 210, one or more wireless interfaces 114, and/or one or more sensors 216 (e.g., one or more inertial sensors, one or more environmental sensors).

Input device(s) 208 may, for example, comprise various buttons, switches, a touch pad, a trackball, a joystick, a touch screen, a microphone, a camera, and/or the like, which may be used to receive one or more user inputs. Output devices 210 may, for example, comprise various devices that may be used in producing a visual output, an audible output, and/or a tactile output for a user.

A wireless interface 114 may, for example, provide connectivity to one or more transmitting devices 110 and/or network(s) 104 (FIG. 1), e.g., via one or more communication links. In certain instances, wireless interface 114 may, for example, represent one or more location receivers that may acquire signals from one or more location services, SPS, etc. (not shown), which may be used in estimating a location of mobile device 102 at certain times. As shown, therefore, wireless interface 114 may comprise one or more receivers 214 for use in acquiring various applicable wireless signals. One or more receivers 214 may generate one or more electrical signals that may be used to represent or otherwise determine, at least in part, one or more sensed parameters 234. Although not illustrated, it should be kept in mind that in certain instances wireless interface 114 may comprise one or more transmitters and/or transceivers. Furthermore, in certain instances wireless interface 114 may support one or more wired medication links.

Sensors 216 may represent one or more inertial sensors, such as, e.g., one or more accelerometers, one or more gyrometers or gyroscopes, and/or the like or some combination thereof. Sensors 216 may represent one or more environmental sensors, such as, e.g., one or more magnetometers, an electronic compass, a barometer, a camera or other like light detector, a microphone or other like sound detector, and/or the like or some combination thereof. Sensors 216 may generate one or more electrical signals that may be used to represent or otherwise determine, at least in part, one or more sensed parameters 234.

Processing unit(s) 202 and/or instructions 252 may, for example, provide or otherwise be associated with one or more encoded electrical signals stored in memory 204, such as, one or more estimated trajectories 220, one or more electronic maps 222 or portions thereof, one or more routability graphs 224 or portions thereof, one or more transition features 226, one or more threshold values 228, one or more motion models 230, one or more estimated states 232, one or more sensed parameters 234, one or more distances 236, one or more motion states 238, one or more estimated position locations 240, and/or the like or any combination thereof, e.g., as described in the various example techniques herein.

In certain example implementations, an estimated state/trajectory 220 may represent an estimated direction of travel or movement of mobile device 102 in an indoor environment based, at least in part, on a routability graph 224 associated with electronic map 222. For example, an estimated state/trajectory 220 may represent an estimated movement of mobile device 102 from a position location corresponding to a first grid point of routability graph 224 to a position location corresponding to a second grid point of routability graph 224. As illustrated in some examples below, routability graph 224 may represent feasible paths that a user of mobile device 102 may be expected to take within the applicable indoor environment using edges to connect adjacent grid points. Routability graph 224 may, for example, identify paths that are deemed feasible because they do not cross through one or more obstacles identified within electronic map 222 that would normally present a barrier to a user of mobile device 102. For example, a user of mobile device 102 would typically not be able to follow a path through a solid wall within an indoor structure. However, a user of a mobile device 102 would typically be able to follow a path through a doorway. Thus, one or more edges may indicate one or more feasible paths through a doorway, and conversely a lack of at least one edge through a wall may indicate that there are no feasible paths through the wall.

Electronic map 222 may represent any encoded data file and/or instruction file capable of representing one or more obstacles within a structure. Thus, for example, electronic map 222 may comprise all or part of one or more CAD drawing(s) and/or the like, depicting one or more obstacles that a user of mobile device 102 may need to navigate about and/or through while located within an indoor environment of the structure. For example, in certain instances electronic map 222 may comprise or otherwise represent a floor plan or other like layout of structural and/or nonstructural obstacles that may be located within an indoor environment.

Routability graph 224 may, for example, represent a plurality of interconnected points representing feasible paths for a user of mobile device 102 with regard to one or more obstacles of electronic map 222. As illustrated herein, in certain instances routability graph 224 may comprise grid points arranged in a uniform manner with respect to one or more obstacles electronic map 222 and which are applicably connected by edges that represent feasible paths for a user of mobile device 102. In certain other example implementations, all or some grid points of a routability graph 224 may be arranged in a non-uniform manner.

A distance 236 may, for example, represent a length of an edge directly connecting two adjacent grid points. Thus, for example, in certain instances distance 236 may represent a length of a horizontal or vertical edge directly connecting two adjacent grid points of a routability graph with respect to the indoor environment. For example, with respect to an indoor environment, to adjacent grid points may correspond to an actual distance within the structure of 0.5 meters. Since a routability map may have various grid patterns, so too may a distance between adjacent grid points vary from one implementation to another. Indeed even in a square pattern and routability graph, there may be different corresponding blanks for edges, e.g., horizontal and vertical edges (as illustrated on the sheets herein) may be the same length but diagonal edges will be longer still. In certain other example implementations, distance 236 may represent a predetermined or otherwise programmable value representing a length that may or may not correspond to a length of an edge within a routability graph 224. For example, in certain instances, a nominal distance value may be used.

Distance 236 may, for example, be used to set or otherwise determine a threshold distance that may be stored as a threshold value 228. Mobile device 102 may, for example, determine whether at least one of a first point or a second point in a routability graph are proximate to a transition feature of at least one barrier based, at least in part, on whether the first and/or second point(s) are within a threshold distance of such a transition feature. In certain example implementations, a threshold distance may be less than or equal to a distance 236. In certain example implementations, a threshold distance may be greater than a distance 236.

Transition features 226 may, for example, represent portions of obstacles within an indoor environment that may be selectively crossed by an estimated state/trajectory of mobile station 102 under certain conditions even though there may be no feasible paths identified in a routability graph to allow for such movement. Thus, for example, one or more transition features 226 may represent one or more objects or portions thereof, and/or other like barrier position identifying information relating to obstacles in an electronic map and/or a routability graph.

Motion model 230 may, for example, represent data and/or instructions encoded and which may be used to determine an estimated state/trajectory of mobile device 102. For example, motion model 230 may process direct or indirect sensed parameters 234 associated with sensor(s) 216 and/or wireless signal receiver(s) 214 to propagate a state of mobile device 102. Such a motion model may, for example, comprise a filtering model such as a Kalman filter or a particle filter to propagate estimated position locations of a mobile device in a trajectory. In a particular implementation, a mobile device may employ a particle filter over a constrained routing graph to incorporate sensed parameters 234 subject to route constraints as may be presented by one or more obstacles which form one or more barriers to a user of mobile device 102. By way of example, motion model 230 may comprise a particle filter in which candidate particles may be propagated along a routing graph according to a particle state and one or more sensed parameter(s) 234. Here, for example candidate particles may be assigned a probability according to one or more sensed parameters and the particles may then be resampled according to a probability distribution. Thus mobile device 102 may, for example, use a motion model 230 to generate a candidate set of particles prior to obtaining sensed parameters. In a particular implementation, aspects of a particle filter may propagate a trajectory of mobile device 102 into areas that may not relate to feasible paths (e.g., an edge in a routability graph). For example, a particle filter may propagate a trajectory off of a predetermined routability graph and through a portion of an obstacle. Rather than simply invalidate such estimated trajectories, under certain conditions mobile device 102 may selectively validate such an estimated state/trajectory, e.g., in response to a determination that at least one of a first point and/or a second point in a routability graph relating to the estimated state/trajectory are proximate to a transition feature of at least one barrier. Thus, a motion model 230 may, for example, selectively validate estimated trajectories that would otherwise appear to violate a strict application of a barrier constraint within a routability graph. Several examples of such selectively validated estimated trajectories are illustrated below. Estimated states 232 may represent or otherwise correspond to one or more grid points of a routability graph, as determined by a motion model.

Sensed parameters 234 may, for example, be based, at least in part, on one or more inertial sensor measurement(s), one or more environmental sensor measurement(s), one or more received wireless signal measurement(s), and/or the like or some combination thereof. Sensed parameters 234 may, for example, be directly or indirectly indicative of a movement or a change in movement, and/or a position location or a change in a position location of mobile device 102. For example, one or more inertial sensor measurements may be indicative of a movement or change in movement of mobile device 102. For example, one or more environmental sensor measurements may be indicative of a movement or change in movement of mobile device 102. For example one or more received wireless signal measurements may be indicative of a movement or a change in movement, or a position location or a change in a position location of mobile device 102, e.g. with respect to one or more transmitting devices, a coordinate system of an electronic map, etc. Here for example, one or more received wireless signal measurements may relate to signal strength measurements and/or changes in signal strength measurements over time, signal phase measurements and/or changes in signal phase measurements over time, and/or possibly various signal propagation times (e.g., time of flight, round trip time, etc.).

Motion state 238 may, for example, represent a perceived manner in which mobile device 102 may be moving. By way of example, motion state 238 may be based, at least in part, on a measured or estimated velocity or possibly acceleration of mobile device 102. Thus, for example, motion state 238 may be indicative of mobile device 102 being carried by a walking or possibly running user. In other examples, motion state 238 may be indicative of mobile device 102 being conveyed, likely along with a user, by some mechanism of transport. Here for example, a motion state 238 may indicate movement due to a moving sidewalk, escalator, elevator, vehicle, etc. Under certain conditions, a threshold distance (e.g. represented by a threshold value 228) may be based, at least in part, on motion state 238. For example, a threshold distance may be increased in response to a determination from motion state 238 that a user of mobile device 102 may be moving quickly, and conversely a threshold distance may be decreased in response to a determination from motion state 238 that a user of mobile device 102 may be moving more slowly. Thus, an estimated state/trajectory of a mobile device 102 may be selectively validated even though it crosses over a corner or other like region of an obstacle presenting barrier to the user. As such, in this example, if a user is moving at a brisk pace it may be beneficial to allow for selective validation of estimated state/trajectory that cuts through more of the corner of an obstacle than might otherwise be allowed for a more slowly moving user. Accordingly, a motion state 238 may be used or otherwise considered to establish a threshold distance with respect to one or more transition features. In certain instances a motion state 238 may, for example, be based at least in part on a stride model, and/or other like pedometer based capability that may estimate or otherwise categorize users movement according to various measurements (e.g., from a one or more sensors).

In certain instances, an estimated location 240 may, for example, represent a location according to a coordinate system relating to an electronic map 222 and/or one or more points of routability graph 224. In certain instances, estimated location 240 may, for example, represent one or more ranges or pseudoranges to one or more transmitting devices.

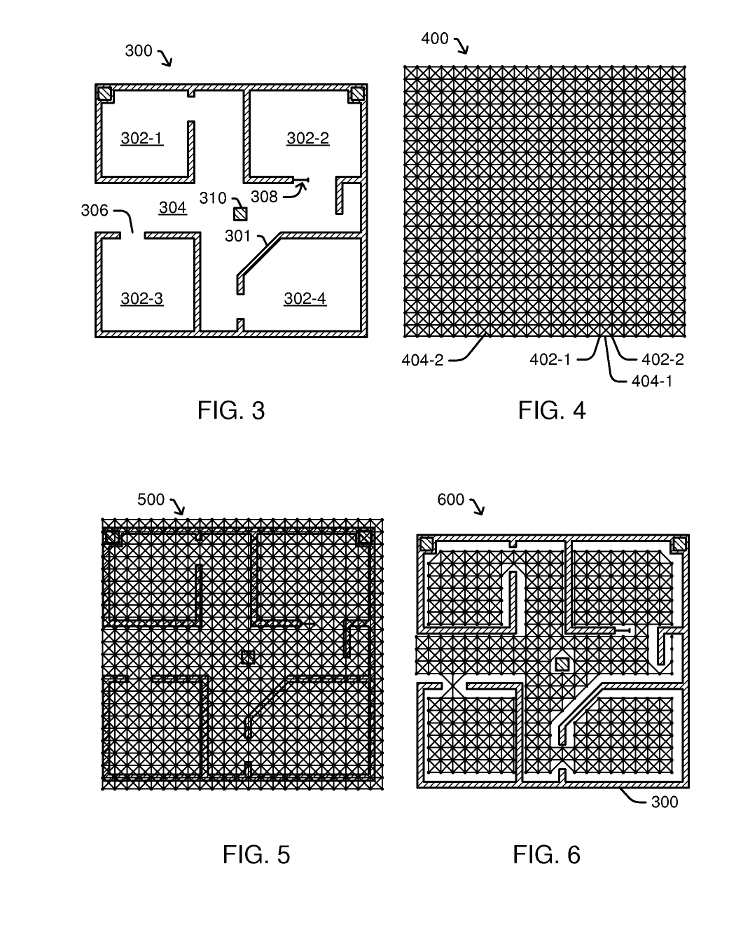

Attention is drawn next to FIG. 3, which is an example floor plan diagram 300 that may be encoded via an electronic map 222 (FIG. 2) or other like diagram and which may identify certain obstacles within an indoor environment of a structure may present barriers to a user of a mobile device 102, in accordance with an implementation.

As shown diagram 300 presents a cross-sectional view of various obstacles in the form of walls 301 or other like dividers 308 that may form rooms 302 shown here interconnected by passageways 304. Additionally, in this example, an obstacle in the form of a support column 310 is also illustrated. More specifically passageways 304 provide interconnectivity to rooms 302-1, 302-2, 302-3, and 302-4, along with other regions, alcoves, etc. and example entryway or doorway 306 is illustrated leading from passageway 304 to room 302-3. Although not illustrated in this example it should be understood that obstacles may take on various forms some of which are structural as shown and others that are nonstructural but also not likely to change (e.g., built in desks, counters, installed machines, etc.). It should also be kept in mind that diagram 300 is not intended to be drawn to any particular scale but is just used for reference herein to demonstrate the use of a routability graph with respect to an indoor environment, in accordance with certain implementations.

FIG. 4 depicts an example grid 400 of points 402 having interconnected edges 404 there between which may represent feasible paths to a user of a mobile device, in accordance with an implementation. In this example, grid 400 is shown as having a uniform distribution in the shape of a square grid pattern wherein points 402 within the interior of grid 400 each have eight edges extending outwardly and directly connecting to eight different adjacent points. As illustrated in grid 400, points 402-1 and 402-2 are adjacent points which are directly connected by a horizontal edge 404-1. Also illustrated, is a diagonal edge 404-2 which in this example as a different length than that of horizontal edge 404-1. Note that in the example all vertical and horizontal edges (e.g., as illustrated on the sheet) have the same lengths.

FIG. 5 is an example projection 500 of an example grid 400 of points, e.g., as in FIG. 4, overlaid on an example floor plan diagram 300, e.g., as in FIG. 3, in accordance with an implementation. As can be seen in projection 500 there is overlap of the objects in diagram 300 with certain grid points and/or edges in grid 400. It is noted that, the size sizes, shapes, patterns, scales, etc., of diagram 300 and/or grid 400 are intended only for use in illustrating some of the example techniques provided herein and claimed subject matter is not necessarily intended to be constrained thereby.

FIG. 6 is an example illustration of an example of routability graph 600 resulting from the projection 500 in FIG. 5, in accordance with an implementation. As can be seen, example routability graph 600 may be illustrated by grid points and interconnecting edges that do not overlap with obstacles presented in diagram 300 which act as a barrier to movement of the user of mobile device 102. Thus for example as can be seen by the remaining grid pattern a user of mobile device 102 may gain entry to the various rooms and passageways within the structure represented by diagram 300.

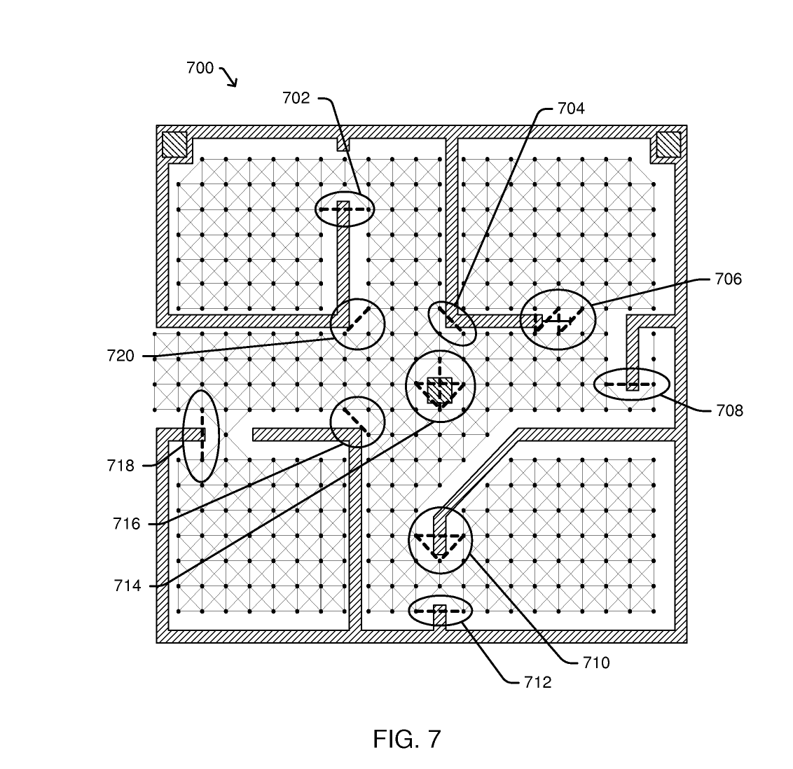

Attention is drawn next to FIG. 7, which is an example illustration as in FIG. 6 further illustrating some example estimated trajectories of a mobile device from first points to second points of a routability graph that may be selectively validated even though the points may not be not directly connected by an edge representing a feasible path for a user of the mobile device, in accordance with certain implementation(s). In each of the illustrated examples, the estimated trajectories are shown as occurring with respect to locations of certain example transition features for barriers relating to certain obstacles.

For example, an estimated trajectory (e.g. illustrated by dashed line) of a mobile device is illustrated in region 702 with regard to a transition feature at a terminus portion (e.g., end) of a wall, and/or a portion or feature of an obstacle forming all or part of an entryway or a doorway, and/or the like. In region 702 the example estimated trajectory crosses horizontally between two points of the routability graph which are separated by a distance equal to two horizontal (or vertical) edges. In certain instances, the example estimated trajectory in region 702 may be validated using the techniques provided herein. Similar horizontal estimated trajectories are illustrated in regions 708, 710, and 712, each of which also depicts example transition features at applicable terminus portions of other walls, and/or entryway or doorway features. Similarly, region 718 illustrates an estimated trajectory that crosses vertically between two points of the routability graph which are separated by a distance equal to two vertical (or horizontal) edges. In region 718, the example estimated vertical trajectory occurs at a transition feature which is a terminus of a wall, and/or a portion of an entryway or doorway feature.

Region 714 also illustrates an example horizontal estimated trajectory that may be selectively validated, however, here the example transition feature is a structural member or other like obstacle having a cross-sectional area measurement that may be less than or equal to a cross-sectional area threshold value. In this example the horizontal estimated trajectory extends between two points of the routability graph that are separated by a distance equal to two horizontal (or vertical) edges. Region 714 also illustrated example vertical estimated trajectory that may be selectively validated. In this example the vertical estimated trajectory extends between two points of the routability graph that are separated by a distance equal to two vertical (or horizontal) edges.

Although the surfaces of the various obstacles presenting barriers to a user of a mobile device are illustrated as being planar or otherwise straight, it should be understood that in other example implementations such obstacles may have non-planar or other like multi-faceted or curved surfaces, etc.

In another example, an estimated trajectory of a mobile device is illustrated in region 704 with regard to a transition feature at a corner portion of a wall. In region 704 the example estimated trajectory crosses diagonally between two points of the routability graph which are separated by a distance equal to two diagonal edges. In certain instances, the example estimated trajectory in region 704 may be validated using the techniques provided herein. Similar diagonal estimated trajectories are illustrated in regions 710, 714, 716 and 720, each of which also depicts example transition features at applicable transition features.

In yet another example, several estimated trajectories of a mobile device are illustrated in region 706 with regard to a transition feature at a terminus portion (e.g., end) of a wall, or an entryway or a doorway feature, which in this instance also includes a distal portion extending outwardly. Here for example the distal portion may be a glass framed section entryway/doorway. Thus, for example, region 706 may qualify as representing or otherwise comprising a transition feature based on a number of different criteria. As illustrated in region 706, in this example there are two vertical estimated trajectories that may be selectively validated and at least two diagonal estimated trajectories that may be selectively validated under certain conditions. Each of the vertical estimated trajectories extends between two applicable points of the routability graph which are separated by a distance equal to one vertical (or horizontal) edge. Each of the diagonal estimated trajectories extends between two applicable points of the routability graph which are separated by a distance equal to two vertical (or horizontal) edges. While not illustrated, it should be noted that region 706 may also support other diagonal estimated trajectories which may be slanted in the opposite direction to those shown. In certain instances, one or more of the example estimated trajectories in region 706 may be validated using the techniques provided herein.

As can be seen in the illustrated examples in FIG. 7, the techniques provided herein may allow for certain estimated trajectories to be validated despite passing through and/or over certain obstacles which would otherwise normally be considered to present a barrier to movement by a user of the mobile device. In certain example implementations the estimated trajectories that are selectively validated may be maintained by a motion model and possibly subsequently used to estimate a position location of a mobile device within an indoor environment. In certain instances, allowing for transition features with regard to certain barriers may reduce complexity and/or data processing requirements. In certain instances allowing for transition features with regard to certain barriers may allow for different sized grid patterns to be used in a routability graph, which may reduce data processing and/or storage requirements. In certain instances allowing for transition features with regard to certain barriers may allow for a particle filter to provide for estimated trajectories that might otherwise not be allowed but which may more accurately reflect movement of a mobile device (e.g. to account for possible errors and/or unaccounted for offsets or other like differences between the routability graph and electronic map). For example, in certain instances, a routability graph may have a grid pattern resolution that at times may allow for certain entry ways or doorways, or other like obstacles, to eliminate all edges that may allow for ingress or egress to certain regions or portions of an indoor environment. For example, wherein a grid pattern of 0.5 meters is overlaid onto a floor layout having an entryway or doorway that is 1.0 meters wide, a resulting routability graph may or may not provide an edge that passes through such an entryway or doorway. However by allowing for a transition feature at or nearby such an entryway or doorway, e.g. as presented in the example techniques herein, may allow a motion model to selectively verify an estimated trajectory that does pass through such an entryway or doorway. Hence, rather than determining a new routability graph e.g. possibly with more grid points in its grid pattern, the example techniques provided herein may permit the use of routability graphs that might not otherwise be effective but which may comprise or result in smaller data files indoor league to reduced data processing time and/or requirements.

Although the example implementations in FIG. 7 illustrate estimated trajectories as being aligned with certain discrete grid points and/or edges of a routability graph, it should be kept in mind that an actual trajectory and/or estimated trajectory need not adhere to such discrete quantizing points and/or edges.

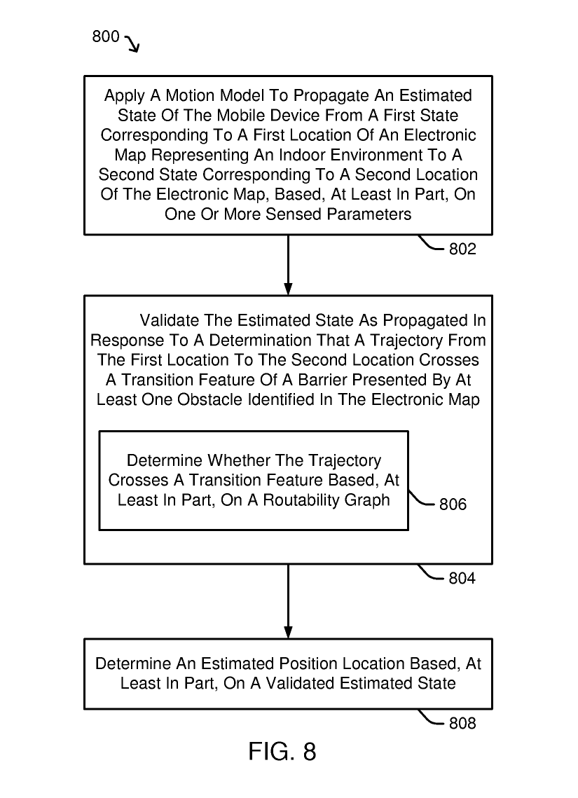

With the above examples and others presented herein in mind, attention is now drawn to FIG. 8, which is a flow diagram illustrating certain features of an example process or method 800 for use in a mobile device 102 to propagate and selectively validate its estimated states/trajectory within an indoor environment of a structure based, at least in part, on an electronic map possibly a routability graph, in accordance with an example implementation.

At example block 802, a motion model may be applied or otherwise used to propagate the estimated state of the mobile device from a first state corresponding to a first location of an electronic map representing an indoor environment to a second state corresponding to a second location of the electronic map. A motion model may, for example, propagate an estimated state based, at least in part, on one or more sensed parameters. A motion model may, for example, use a particle filter and/or the like, as is well known.

At example block 804 an estimated state as propagated may be validated in response to a determination that a trajectory from the first location to the second location crosses a transition feature of a barrier represented by at least one obstacle identified in the electronic map. In certain instances, for example and estimated trajectory that falls on or near to a first point and a second point of routability graph may be selectively validated even though the first and second points of the routability graph are not directly connected by an edge representing a feasible path. By way of example, the selective validation of an estimated state at example block 806 may be made in response to a determination that at least one of the first point (e.g., near the first location) or the second point (e.g., near the second location) of a routability graph are proximate (e.g., based on one or more threshold distance or other like values) to a transition feature of at least one barrier identified in the electronic map. For example, one or more distance values may be used to identify whether or not a grid point is or is not within a proximity to a transition feature. As mentioned, in certain examples, such a determination as to whether or not a grid point is proximate to a transition feature of at least one barrier may depend, at least in part, on a type of transition feature, a motion state, and/or other like factors or some combination thereof. In certain instances one or more threshold values may be considered to determine whether or not a grid point is proximate to a transition feature. In certain instances one or more threshold values may be determined based, at least in part, on one or more distances relating to edges and the routability graph. For example, in certain instances, selective validation may require that at least one of the grid points is within at least one edge distance of a transition feature. In other instances, selective validation may occur provided that at least one of the grid points is within two edge distances of a transition feature.

At example block 808, an estimated position location of the mobile device within an indoor environment may be determined based, at least in part, on a selectively validated estimated state. In certain instances, an indication of an estimated position location of the mobile device may be presented to a user, e.g., via one or more output devices. Here, for example, a navigation application or other like positioning application may be provided to assist user of the mobile device while moving within an indoor environment. In certain instances, an estimated position location of the mobile device may be transmitted to or otherwise provided to one or more other devices. For example, an estimated position location of the mobile device may be provided to an emergency 911 service responder, etc., to locate a user of a mobile device, and/or to some other location based service provider to provide additional services to the user of a mobile device.

Thus as shown in the examples herein estimated trajectories of the mobile device may be selectively validated even though they may violate strict constraints identified in a routability graph. In certain example implementations, an estimated state/trajectory may be selectively validated based, at least in part, on a progression of a trajectory from a previous state to propagate state. In one example trajectory may be considered valid even though the trajectory crosses an obstruction, provided that the trajectory crosses the obstructions by less than a predetermined distance (e.g., at a transition feature). In one implementation a predetermined distance may be determined to be a distance defined by an edge connecting adjacent grid points.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

The methodologies described herein may be implemented by various means depending upon applications according to particular features and/or examples. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining”, “establishing”, “obtaining”, “identifying”, “maintaining” and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general purpose computer once it is programmed to perform particular functions pursuant to instructions from program software.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

What is claimed is:

1. A method of estimating a state of a mobile device comprising, with the mobile device:
applying a motion model to propagate an estimated state of said mobile device from a first state corresponding to a first location of an electronic map representing an indoor environment to a second state corresponding to a second location of said electronic map, based, at least in part, on one or more sensed parameters; and
validating said estimated state as propagated in response to a determination that a trajectory from said first location to said second location crosses a transition feature of a barrier presented by at least one obstacle identified in said electronic map.

2. The method as recited in claim 1, and further comprising with said mobile device:
determining whether said trajectory from said first location to said second location crosses said transition feature of said barrier based, at least in part, on a routability graph corresponding to said electronic map.

3. The method as recited in claim 2, wherein said routability graph represents a discrete quantization of a plane overlaying said electronic map, and comprises a plurality of discrete points wherein adjacent points are connected by an edge if there are no intervening obstacles identified in said electronic map between said adjacent points, and further comprising, with said mobile device:
identifying at least one of said plurality of discrete points with at least one of said first location or said second location; and
determining whether said trajectory from said first location to said second location crosses said transition feature of said barrier based, at least in part, on a determination that said at least one of said plurality of discrete points is proximate to said transition feature of said barrier.

4. The method as recited in claim 1, wherein said transition feature comprises at least one of: a terminus portion of said at least one obstacle; a corner portion of said at least one obstacle; a faceted portion of said at least one obstacle; a curved or non-planar portion of said at least one obstacle; a distal portion of said at least one obstacle; a portion of said at least one obstacle forming part of an entryway; or a portion of said at least one obstacle forming part of a doorway.

5. The method as recited in claim 1, wherein said transition feature of said barrier comprises a cross-sectional area portion of said at least one obstacle having a cross-sectional area measurement that is less than a cross-sectional area threshold value.

6. The method as recited in claim 1, wherein at least one of said one or more sensed parameters is based, at least in part, on at least one of: an inertial sensor measurement; an environmental sensor measurement; or a received wireless signal measurement.

7. The method as recited in claim 1, wherein said motion model comprises a particle filter.

8. The method as recited in claim 3, and further comprising, with said mobile device:
determining whether said trajectory from said first location to said second location crosses said transition feature of said barrier based, at least in part, on a determination that said at least one of said plurality of discrete points is within a threshold distance of said transition feature.

9. The method as recited in claim 8, wherein said threshold distance is determined based, at least in part, on at least one distance between discrete points represented in said routability graph.

10. The method as recited in claim 9, wherein said threshold distance is less than or equal to said at least one distance between said discrete points represented in said routability graph.

11. The method as recited in claim 8, wherein said threshold distance is based, at least in part, on a type of obstacle associated with said barrier.

12. The method as recited in claim 8, wherein said threshold distance is based, at least in part, on a motion state associated with said mobile device.

13. The method as recited in claim 1, and further comprising, with said mobile device:
determining an estimated position location of said mobile device within said indoor environment based, at least in part, on a validated estimated state of said mobile device.

14. An apparatus for use in a mobile device, the apparatus comprising:
means for propagating an estimated state of said mobile device from a first state corresponding to a first location of an electronic map representing an indoor environment to a second state corresponding to a second location of said electronic map, based, at least in part, on one or more sensed parameters; and
means for validating said estimated state as propagated in response to a determination that a trajectory from said first location to said second location crosses a transition feature of a barrier presented by at least one obstacle identified in said electronic map.

15. The apparatus as recited in claim 14, and further comprising:
means for determining whether said trajectory from said first location to said second location crosses said transition feature of said barrier based, at least in part, on a routability graph corresponding to said electronic map.

16. The apparatus as recited in claim 15, wherein said routability graph represents a discrete quantization of a plane overlaying said electronic map, and comprises a plurality of discrete points wherein adjacent points are connected by an edge if there are no intervening obstacles identified in said electronic map between said adjacent points, and further comprising:
means for identifying at least one of said plurality of discrete points with at least one of said first location or said second location; and
means for determining whether said trajectory from said first location to said second location crosses said transition feature of said barrier based, at least in part, on a determination that said at least one of said plurality of discrete points is proximate to said transition feature of said barrier.

17. The apparatus as recited in claim 14, wherein said transition feature comprises at least one of: a terminus portion of said at least one obstacle; a corner portion of said at least one obstacle; a faceted portion of said at least one obstacle; a curved or non-planar portion of said at least one obstacle; a distal portion of said at least one obstacle; a portion of said at least one obstacle forming part of an entryway; or a portion of said at least one obstacle forming part of a doorway.

18. The apparatus as recited in claim 14, wherein said transition feature of said barrier comprises a cross-sectional area portion of said at least one obstacle having a cross-sectional area measurement that is less than a cross-sectional area threshold value.

19. The apparatus as recited in claim 16, and further comprising:
means for determining whether said trajectory from said first location to said second location crosses said transition feature of said barrier based, at least in part, on a determination that said at least one of said plurality of discrete points is within a threshold distance of said transition feature.

20. The apparatus as recited in claim 19, wherein said threshold distance is determined based, at least in part, on at least one distance between discrete points represented in said routability graph.

21. The apparatus as recited in claim 20, wherein said threshold distance is less than or equal to said at least one distance between said discrete points represented in said routability graph.

22. The apparatus as recited in claim 19, wherein said threshold distance is based, at least in part, on a type of obstacle associated with said barrier.

23. The apparatus as recited in claim 19, wherein said threshold distance is based, at least in part, on a motion state associated with said mobile device.

24. The apparatus as recited in claim 14, and further comprising:
means for determining an estimated position location of said mobile device within said indoor environment based, at least in part, on a validated estimated state of said mobile device.

25. A mobile device comprising:
memory; and
one or more processing units configured to:
use a motion model to propagate an estimated state of said mobile device from a first state corresponding to a first location of an electronic map representing an indoor environment to a second state corresponding to a second location of said electronic map, based, at least in part, on one or more sensed parameters; and
validate said estimated state as propagated in response to a determination that a trajectory from said first location to said second location crosses a transition feature of a barrier presented by at least one obstacle identified in said electronic map.

26. The mobile device as recited in claim 25, said one or more processing units configured to further:
determine whether said trajectory from said first location to said second location crosses said transition feature of said barrier based, at least in part, on a routability graph corresponding to said electronic map.

27. The mobile device as recited in claim 26, wherein said routability graph represents a discrete quantization of a plane overlaying said electronic map, and comprises a plurality of discrete points wherein adjacent points are connected by an edge if there are no intervening obstacles identified in said electronic map between said adjacent points, and wherein said one or more processing units configured to further:
identify at least one of said plurality of discrete points with at least one of said first location or said second location; and
determine whether said trajectory from said first location to said second location crosses said transition feature of said barrier based, at least in part, on a determination that said at least one of said plurality of discrete points is proximate to said transition feature of said barrier.

28. The mobile device as recited in claim 25, wherein said transition feature comprises at least one of: a terminus portion of said at least one obstacle; a corner portion of said at least one obstacle; a faceted portion of said at least one obstacle; a curved or non-planar portion of said at least one obstacle; a distal portion of said at least one obstacle; a portion of said at least one obstacle forming part of an entryway; or a portion of said at least one obstacle forming part of a doorway.

29. The mobile device as recited in claim 25, wherein said transition feature of said barrier comprises a cross-sectional area portion of said at least one obstacle having a cross-sectional area measurement that is less than a cross-sectional area threshold value.

30. The mobile device as recited in claim 25, and further comprising:
at least one sensor comprising at least one of an inertial sensor, an environmental sensor, or a wireless signal receiver; and
wherein said one or more processing units configured to further obtain at least one of said one or more sensed parameters from said at least one sensor.

31. The mobile device as recited in claim 25, wherein said motion model comprises a particle filter.

32. The mobile device as recited in claim 27, said one or more processing units configured to further:
determine whether said trajectory from said first location to said second location crosses said transition feature of said barrier based, at least in part, on a determination that said at least one of said plurality of discrete points is within a threshold distance of said transition feature.

33. The mobile device as recited in claim 32, wherein said threshold distance is determined based, at least in part, on at least one distance between discrete points represented in said routability graph.

34. The mobile device as recited in claim 33, wherein said threshold distance is less than or equal to said at least one distance between said discrete points represented in said routability graph.

35. The mobile device as recited in claim 32, wherein said threshold distance is based, at least in part, on a type of obstacle associated with said barrier.

36. The mobile device as recited in claim 32, wherein said threshold distance is based, at least in part, on a motion state associated with said mobile device.

37. The mobile device as recited in claim 25, said one or more processing units configured to further:
determine an estimated position location of said mobile device within said indoor environment based, at least in part, on a validated estimated state of said mobile device.

38. An article comprising:
a non-transitory computer readable medium having computer implementable instructions stored therein that are executable by one or more processing units of a mobile device to:
apply a motion model to propagate an estimated state of said mobile device from a first state corresponding to a first location of an electronic map representing an indoor environment to a second state corresponding to a second location of said electronic map, based, at least in part, on one or more sensed parameters; and
validate said estimated state as propagated in response to a determination that a trajectory from said first location to said second location crosses a transition feature of a barrier presented by at least one obstacle identified in said electronic map.

39. The article as recited in claim 38, said computer implementable instructions being further executable by said one or more processing units to:
determine whether said trajectory from said first location to said second location crosses said transition feature of said barrier based, at least in part, on a routability graph corresponding to said electronic map.

40. The article as recited in claim 39, wherein said routability graph represents a discrete quantization of a plane overlaying said electronic map, and comprises a plurality of discrete points wherein adjacent points are connected by an edge if there are no intervening obstacles identified in said electronic map between said adjacent points, and wherein said computer implementable instructions being further executable by said one or more processing units to:
identify at least one of said plurality of discrete points with at least one of said first location or said second location; and
determine whether said trajectory from said first location to said second location crosses said transition feature of said barrier based, at least in part, on a determination that said at least one of said plurality of discrete points is proximate to said transition feature of said barrier.

41. The article as recited in claim 38, wherein said transition feature comprises at least one of: a terminus portion of said at least one obstacle; a corner portion of said at least one obstacle; a faceted portion of said at least one obstacle; a curved or non-planar portion of said at least one obstacle; a distal portion of said at least one obstacle; a portion of said at least one obstacle forming part of an entryway; or a portion of said at least one obstacle forming part of a doorway.

42. The article as recited in claim 38, wherein said transition feature of said barrier comprises a cross-sectional area portion of said at least one obstacle having a cross-sectional area measurement that is less than a cross-sectional area threshold value.

43. The article as recited in claim 38, wherein at least one of said one or more sensed parameters is based, at least in part, on at least one of: an inertial sensor measurement; an environmental sensor measurement; or a received wireless signal measurement.

44. The article as recited in claim 38, wherein said motion model comprises a particle filter.

45. The article as recited in claim 40, said computer implementable instructions being further executable by said one or more processing units to:
determine whether said trajectory from said first location to said second location crosses said transition feature of said barrier based, at least in part, on a determination that said at least one of said plurality of discrete points is within a threshold distance of said transition feature.

46. The article as recited in claim 45, wherein said threshold distance is determined based, at least in part, on at least one distance between discrete points represented in said routability graph.

47. The article as recited in claim 46, wherein said threshold distance is less than or equal to said at least one distance between said discrete points represented in said routability graph.

48. The article as recited in claim 45, wherein said threshold distance is based, at least in part, on a type of obstacle associated with said barrier.

49. The article as recited in claim 45, wherein said threshold distance is based, at least in part, on a motion state associated with said mobile device.

50. The article as recited in claim 38, said computer implementable instructions being further executable by said one or more processing units to:
determine an estimated position location of said mobile device within said indoor environment based, at least in part, on a validated estimated state of said mobile device.
